(19) United States
(12) Patent Application Publication
(10) Pub. No.: US 2013/0264998 A1
(43) Pub. Date: Oct. 10, 2013

(54) SMART CHARGER FOR PERSONAL MEDIA DEVICES

(71) Applicant: IMATION CORP, Oakdale, MN (US)

(72) Inventors: Eran Schul, St. Paul, MN (US); Joseph J. Fleury, Woodbury, MN (US)

(73) Assignee: Imation Corp., Oakdale, MN (US)

(21) Appl. No.: 13/826,717

(22) Filed: Mar. 14, 2013

Related U.S. Application Data
(60) Provisional application No. 61/622,255, filed on Apr. 10, 2012.

(51) Int. Cl. H02J 7/00

(52) U.S. Cl. CPC H02J 7/0047
USPC 320/107

(57) ABSTRACT

Presenting battery-charging status information to a user of a personal media device, even when that personal media device is in a dormant mode responsive to a battery charging operation. A charging element responds to new messages with alerts. The charging element presents at least one of an amount charged or an amount of time left to fully charge, using associated graphics for easier viewing. Content from a media library can be presented in response to indicators. An application executing on the personal media device can operate with a control program executing on the charging element itself, to control one or more display features of the charging element.

This application claims priority to U.S. Provisional Application No. 61/622,255, filed Apr. 10, 2012, which is hereby incorporated by reference in its entirety.

### BACKGROUND OF THE DISCLOSURE

By virtue of being mobile, MP3 players, smartphones, and other personal media devices include batteries, for use when disconnected from electric power sources. These batteries are discharged when used, and must periodically, even frequently, be recharged. To speed up the recharging process, personal media devices (or sometimes just their display elements) enter a dormant mode, also called a “sleep mode”, during which nearly all activities are disabled from operation.

One problem in the known art is that, when personal media devices or in this dormant mode or “sleep mode”, their users cannot easily determine the status of the personal media device without manually waking up the device. For example, users cannot easily determine when the charging operation is complete, or when other events of interest to the user occur, such the receipt of incoming messages, without manually waking up the device.

While it is possible for the personal media device to continue operation while charging, this has the drawback that it can slow the charging operation, and has the further drawback that it may have an adverse effect on the device battery. Moreover, if the user sets the parameters for the personal media device to disable audible notifications, it can easily occur that new message notifications might be missed by the user.

Hans et al., US 2010/0197280 A1, “Transceiver with message notification”, describes a mobile phone operating in a charging mode with the sound and display turned off. Upon receipt of an SMS message or a voicemail message, the mobile phone described in Hans turns on a dual-color LED to indicate receipt of the message. While Hans describes a system which generally achieves the purpose of notifying the user of incoming new messages, it has the drawback that it involves modification of the mobile phone to include additional display elements. Moreover, Hans does not address the problems described above.

### SUMMARY OF THE DISCLOSURE

We provide techniques for presenting information to a user of a personal media device, even when that personal media device is in a dormant mode responsive to a battery charging operation.

A personal media device, such as a cellular telephone, touchpad or tablet computer, or other personal media device, when in a dormant mode responsive to a battery charging operation (or other dormant mode, such as a battery conservation mode), presents information to a user indicating a device status. When the personal media device enters the dormant mode, a charging element is conditioned to respond to one or more new messages (or other types of new information), in response to which the user desires an alert.

The charging element can include a charging operation status of the personal media device, such as an amount charged or an amount of time left to fully charge, along with a display element disposed to present associated graphics which make viewing the presented information easier for the user. The status of the personal media device can also include indicators presenting whether new messages have arrived for the user, such as new email, new text messages, new voicemail, a charging-completed alarm, or any other new information in response to which the user desires an alert.

In one embodiment, content from a media library (such as audio, photo, or video) can be presented to the user in response to one or more, or some combination or conjunction of, these indicators, or other indicators. For example, the user can select one or more photo or video presentation elements responsive to new messages, or one or more audio presentation elements responsive to charging completion (or a condition near to charging completion), with which the charging element can alert the user.

In one embodiment, the media library can be local to the personal media device or local to the charging element, or can be retrieved from one or more other devices accessible to the personal media device or to the charging element. These other devices can be coupleable to the personal media device or to the charging element, using either a wireless or wired communication path.

In one embodiment, an application executes on the personal media device and can control one or more display features of the charging element. An application executing on the personal media device can operate in conjunction with, or operate as a substitute for, a control program executing on the charging element itself. For example, the application can alter the brightness of the display element on the charging device, alter one or more display settings for the display element on the charging device, turn an alarm on or off, or alter a volume for an alarm, for the charging device, or otherwise customize display settings (or other settings) for the charging device. More generally, an application program executing on the personal media device can operate in conjunction with, or operate as a substitute for, a control program executing on the charging element, with respect to any operation of the charging element described herein.

### BRIEF DESCRIPTION OF THE DRAWINGS

FIG. 1 (collectively including FIG. 1A, 1B, 1C, and 1D) shows a conceptual drawing of a first charging system.

FIG. 2 (collectively including FIG. 2A, 2B, and 2C) shows a conceptual drawing of a second charging system.

FIG. 3 shows a conceptual drawing of a personal media device display.

In the figures, similar components or features might have the same reference label. Similar components or features, or those of the same type, might be distinguished by following the reference label by a dash and a second label that distinguishes them. Where only the first reference label is used, the description is applicable to any similar component having the same first reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiments of the disclosure. It should be understood that various changes may be made in the function and arrangement of elements without departing from the spirit and scope of the invention as set forth in the appended claims.

Terms and Phrases

The text “application” generally refers to any program, set of instructions, or other one or more control elements, capable of being executed or interpreted by a personal media device. The text “control program” generally refers to any program, set of instructions, or other one or more control elements, capable of being executed or interpreted by a personal charging device. In general, in this application, where an action is described as being controllable by an application, it is also contemplated that the action could be controllable by a control program, or by some combination of the two.

The text “battery” generally refers to any device capable of storing energy in electrical form, or convertible to electrical form, including chemical batteries (such as “coin” batteries, lithium batteries, nickel metal hydride batteries), fuel cells, and any device employing any other technique capable of energy storage.

The text “charging device” generally refers to any device capable of acting with respect to the charging status of one or more personal media devices, including without limitation, charging those devices, presenting a charging status of those devices, discharging those devices, and otherwise.

The text “display” generally refers to any device capable of presenting information from a device to a user, including audio-visual displays, haptic displays, and any device employing any other technique capable of providing a user with data or information.

The text “personal media device” generally refers to any device capable of accessing media signals and generating audio signals for presentation to a listener. Example personal media devices include MP3 players, smartphones, and other devices. Smartphones include, for example, the iPhone™ by Apple Corporation, as well as phones using the Android™ operating system. Other devices include, for example, the iPod™ and iPad™ by Apple Corporation, the Kindle Fire™ by Amazon Corporation, as well as other touchpads or tablet computers, netbooks, laptops, and personal computers, as well as equivalent consumer electronic devices.

Figures and Text

First System

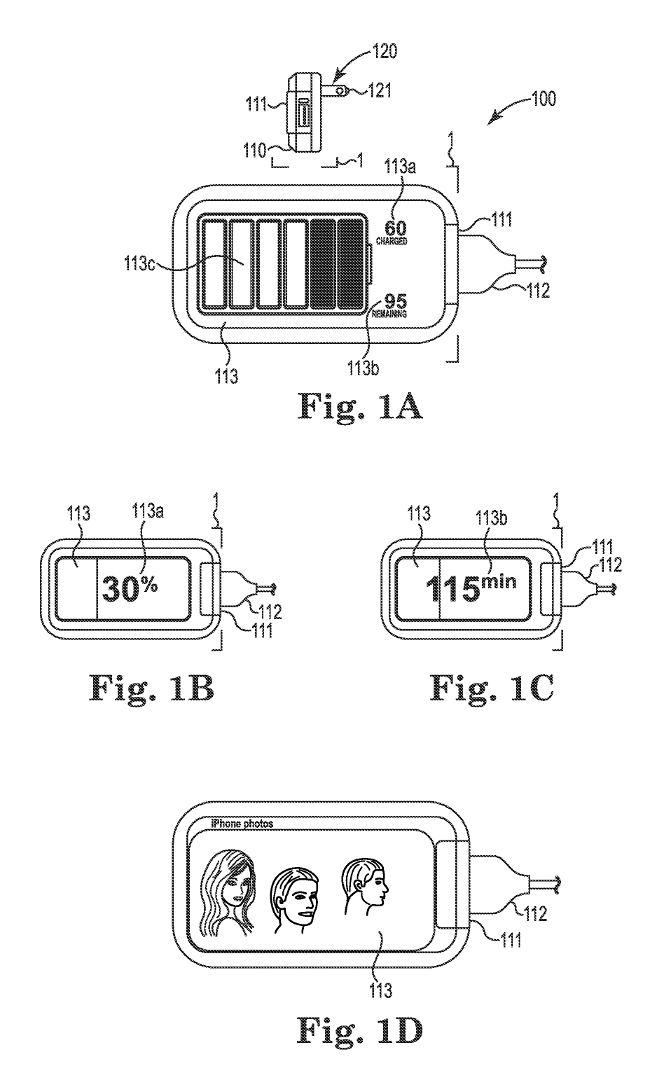

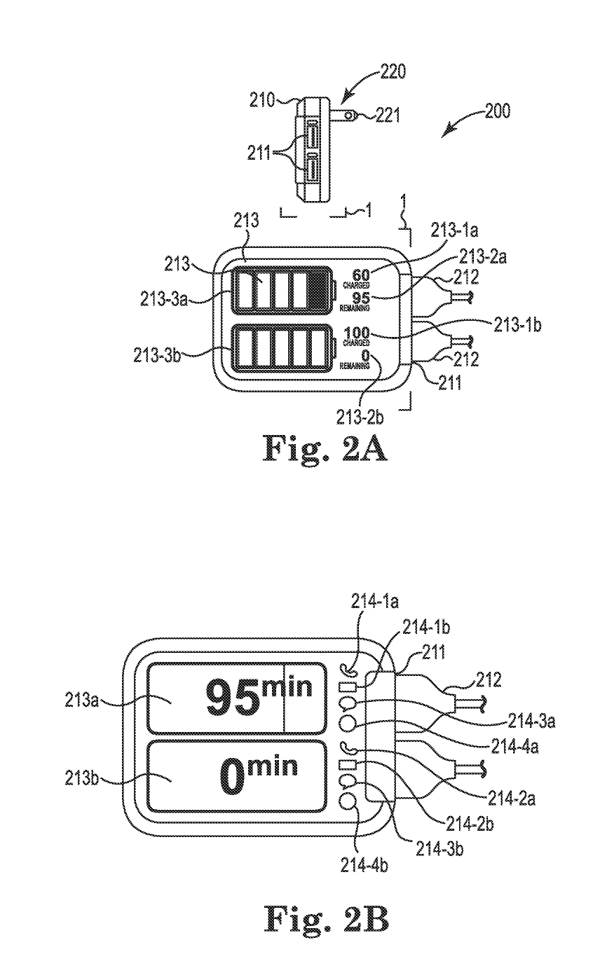

FIG. 1 (collectively including FIG. 1A, 1B, 1C, and 1D) shows a conceptual drawing of a first charging system.

A first system 100 includes elements shown in the figure, including at least a first housing 110 and a first charging connector 120, the figure showing two views as shown along the plane 1. The first housing 110 includes a first cable jack 111 disposed for coupling to a cable 112, which is coupleable to the personal mobile device (not shown). The first charging connector 120 includes a charging plug 121 disposed for coupling to an electrical jack (not shown), which is capable of charging the battery associated with the personal mobile device. The first housing 110 includes a first display region 113.

FIG. 1A shows a first example embodiment of the display region 113. In one embodiment, the display region 113 includes a charging fraction display 113a, showing a battery percentage charge, a charging time display 113b, showing an estimated time to complete charging, and a charging status display 113c, showing an approximate battery status, such as in increments of 20% to complete charging of the battery.

For example, the charging fraction display 113a can include a digital indicator of a fraction of the maximum battery charge, such as “60%”, as indicated in the figure.

Similarly, the charging time display 113b can include a digital indicator of a number of minutes estimated to complete charging, such as “95 min” (minutes), as indicated in the figure.

Similarly, the charging status display 113c can include a bar graph showing quantized increments to complete charging of the battery, such as each bar indicating 20% charge, as indicated in the figure.

In alternative embodiments, the personal mobile device may include more than one battery, and the display region 113 may (optionally) include correspondingly more than one of the displays described with respect to the display region 113, that is, (optionally) more than one charging fraction display 113a, (optionally) more than one charging time display 113b, and (optionally) more than one charging status display 113c. The more than one such display region 113 may be disposed horizontally or vertically, or in some other display arrangement within the display region 113.

FIG. 1B shows a second example embodiment of the display region 113. In one embodiment, the display region 113 does not include all three of the charging fraction display 113a, charging time display 113b, and charging status display 113c. Instead the display region 113 can include fewer displays, such as only the charging fraction display 113a, showing a battery percentage charge, such as a bar chart or progress bar indicating a battery percentage charge, (optionally) combined with a textual description of that fraction, such as “30%”, as indicated in the figure.

FIG. 1C shows a third example embodiment of the display region 113. As described with respect to FIG. 1B, in one embodiment, the display region 113 does not include all three of the charging fraction display 113a, charging time display 113b, and charging status display 113c. Instead the display region 113 can include fewer displays, such as only the charging time display 113b, showing an estimated time to complete charging, such as a bar chart or progress bar indicating a fraction of actual charge, (optionally) combined with the actual description of that estimated time, such as “115 min” (minutes), as indicated in the figure.

FIG. 1D shows a fourth example embodiment of the display region 113. In one embodiment, the display region 113 does not necessarily include any of the charging fraction display 113a, charging time display 113b, or charging status display 113c. Instead the display region 113 can include a photo or video display, such as selected by a user (not shown) to indicate a condition in response to which the user desires an alert.

In one embodiment, the user can select one or more photo or video displays for each of more than one possible such alert. For example, the user can select a first photo or video to be displayed in response to one or more new email messages, a second photo or video to be displayed in response to one or more new text messages, and a third photo or video to be displayed in response to one or more new voicemail messages. As shown in the figure, the user has selected either a particular photo, or a particular video (of which only a still photo is shown) to be presented in response to one or more new messages.

In alternative embodiments, the user may select—to be presented in response to one or more new messages—one or more audio presentations, such as music, ring tones, voice alerts, or otherwise, to be presented in addition to or in lieu of, one or more photo or video displays. For example, the user may select a video selection to be presented in response to a new message, in combination with a soundtrack associated with that video selection.

In one embodiment, the user can select a charging-completed alarm, to be presented in response to completion of a charging operation of the battery associated with the personnel media device. For example, the user can select one or more photo or video displays, one or more audio recitations, some combination or conjunction thereof, or otherwise, to be presented.

In each embodiment involving user-selected content, the user selected content can include one or more of the following, some combination or conjunction thereof, or otherwise:
one or more photo or video displays, such as for example a picture, a picture sequence or slide show, or a motion picture. The photo or video displays can include one or more transition sequences, such as a “dissolve” from one slide to the next in a slide show.
one or more audio presentations, such as for example music or speech (whether recorded or produced as text-to-speech). The music or speech can include one or more transition sequences, such as from one song to the next in a playlist of songs.

In each embodiment involving user-selected content, the user-selected content can be retrieved from a media library accessible to the personal media device, such as for example from a memory or mass storage. The media library can be coupled to the personal media device using a wired or wireless connection, some combination or conjunction thereof, or otherwise.

In one embodiment, content from the media library can be presented in the display region 113 in response to one or more, or some combination or conjunction of, those indicators described above. Example indicators include, as described above, new messages, charging completion (or a condition near to charging completion, such as charging being 95% complete)

Second System

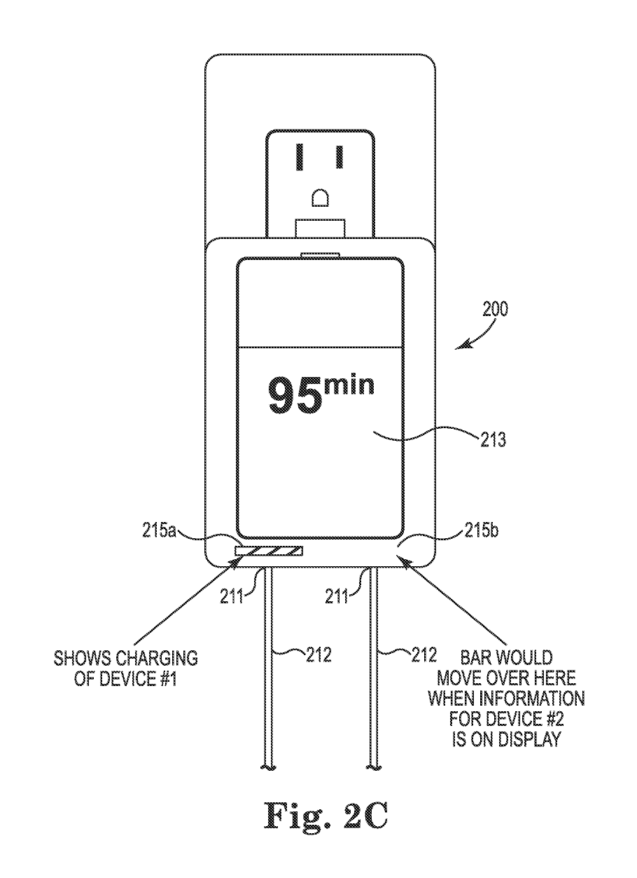

FIG. 2 (collectively including FIG. 2A, 2B, and 2C) shows a conceptual drawing of a second charging system.

A second system 200 includes elements shown in the figure, including at least a second housing 210 and a second charging connector 220. The second housing 210 includes a set of second cable jacks 211 disposed for coupling to a set of cables 212, which are coupleable to one or more personal mobile devices (not shown), each of which is capable of charging the battery associated with the personal mobile device. For example, the cables 212 can include two cable plugs (not shown) coupleable to cable jacks (not shown) associated with one personal mobile device. Alternatively, the cables 212 can include two cable plugs coupleable to cable jacks associated with more than one personal mobile device, each of which is capable of charging the battery associated with the personal mobile device.

Similar to the first housing 110, the second housing 210 includes a second display region 213.

FIG. 2A shows a first example embodiment of the second display region 213. In one embodiment, similar to the first display region 113, the second display region 213 includes a first and a second charging fraction display 213-1a and 213-2a, showing a first and a second battery percentage charge respectively, a first and a second charging time display 213-1b and 213-2b, showing a first and a second estimated time to complete charging respectively, and a first and a second charging status display 213-1c and 213-2c respectively, showing a first and a second approximate battery status respectively, such as in increments of 20% to complete charging of the battery.

For example, the first or the second charging fraction display 213-1a or 213-2a can include a digital indicator of a fraction of the maximum battery charge, such as “60%” or “100%” respectively, as indicated in the figure.

Similarly, the charging time display 213-1b or 213-2b can include a digital indicator of a number of minutes estimated to complete charging, such as “95 min” or “0 min” (minutes) respectively, as indicated in the figure.

Similarly, the charging status display 213-1c or 213-2c can include a bar graph showing quantized increments to complete charging of the battery, such as each bar indicating 20% charge, as indicated in the figure.

FIG. 2B shows a second example embodiment of the display region 213. In one embodiment, the display region 213 does not include all three of the charging fraction display 213a, charging time display 213b, and charging status display 213c. Instead the display region 213 can include fewer displays, or can include similar displays disposed alternatively.

For one example, the display region 213 can show only the charging fraction display 213a, showing a battery percentage charge, such as a bar chart or progress bar indicating a battery percentage charge, (optionally) combined with a textual description of that fraction.

For another example, the display region 213 can show only the charging time display 213b, showing an estimated time to complete charging, such as a bar chart or progress bar indicating a fraction of actual charge, (optionally) combined with the actual description of that estimated time, such as “95 min” or “0 min” (minutes), as indicated in the figure.

The display region 213 can also include a set of icons 214-1 and 214-2, including toner 214-1a and 214-2a, each indicating a new voice message, 214-1b and 214-2b, each indicating a new e-mail message, 214-1c and 214-2c, each indicating a new text message, and 214-1d and 214-2d, each indicating a charge-completed alarm. As shown in the figure, the display region 213 can include one such set of icons 214-1 and 214-2 for each battery, such as in embodiments in which the charging display is associated with more than one personal media device, each having one battery, or such as in embodiments in which the charging display is associated with one personal media device, itself having more than one battery.

When the display region 213 includes one or more icons 214-1 and 214-2, the icons 214-1 and 214-2 can be presented using LED's, LCD's, or other elements disposed for review by a user of the device. For example, the icons 214-1 and 214-2 can be multi-color LED's, LCD's, or any other technologies capable of presenting information.

Similar to the display region 113, in alternative embodiments, the display region 213 does not necessarily include any of the charging fraction display 213a, charging time display 213b, and charging status display 213c. Instead the display region 213 can include a photo or video display, such as selected by a user (not shown) to indicate a condition in response to which the user desires an alert.

Multi-Device Presentation Indicator

FIG. 2C shows a third example embodiment of the display region 213.

In embodiments in which the second cable jacks 211 and cables 212 are coupled to more than one personal mobile device (not shown), the system 200 can include one or more indicator bars 215a and 215b, in which the first indicator bar 215a shows that information is being presented about a first personal mobile device, and in which the second indicator bar 215b shows that information is being presented about a second personal mobile device.

In one embodiment, the second system 200 could charge the two separate personal mobile devices concurrently, or could charge one followed by the other.

For a first example, when the second system 200 charges two separate personal mobile devices concurrently, the second system 200 can alternate which indicator bar 215a and 215b is active, activating the first indicator bar 215a when displaying information about the first personal mobile device, and activating the second indicator bar 215b when displaying information about the second personal mobile device. In this example, the first indicator bar 215a and the second indicator bar 215b would appear to move back and forth, similar to a blinking light.

For a second example, when the second system 200 charges two separate personal mobile devices one followed by the other, the second system 200 can activate indicator bar 215a for the time when the first personal mobile device is charging, followed by activating indicator bar 215b when the second personal mobile device is charging. In this example, the first indicator bar 215a and the second indicator bar 215b would appear as a progress indicator, moving from the first indicator bar 215a to the second indicator bar 215b when the second system 200 progresses from charging the first personal mobile device to charging the second personal mobile device.

For a third example, the second system 200 can switch between presenting information about a first personal mobile device, activating first indicator bar 215a when doing so, and presenting information about a second personal mobile device, activating second indicator bar 215b when doing so, under control of an application or control program. The application or control program can be executed on the first personal mobile device, the second personal mobile device, both concurrently or in conjunction (such as for example in a multi-processing mode), or otherwise. The indicators can be configured in any desired configuration.

In alternative embodiments, the second system 200 can include more than two second cable jacks 211 and cables 212, either by physical construction, or by use of one or more multiplexing elements (not shown). In such alternative embodiments, the second system 200 can include a sufficient multiplicity of indicator bars that the user can readily determine for which personal media device the second system 200 is presenting information. For example, the second system 200 could include one such indicator bar for each such personal media device, or could include enough such indicator bars to display a code for one such personal media device, or otherwise.

Alert Messages

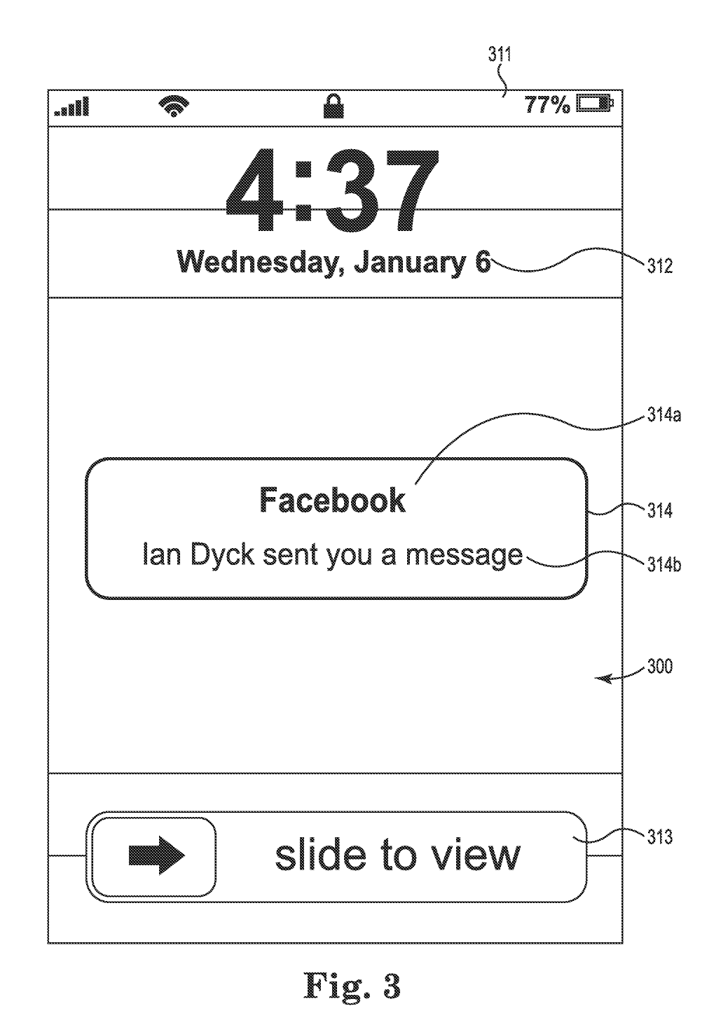

FIG. 3 shows a conceptual drawing of a personal media device display.

A personal media device includes a display 300 capable of presenting information to a user (not shown). In one embodiment, the display 300 includes presentation elements, such as for example a status bar 311, a time and date indicator 312, an unlock slider 313, and an alert message 314. While, in this example, the display 300 generally presents the appearance of an iPhone™, in the context of the invention, there is no particular requirement for any such limitation. For example, the display 300 can present the appearance of a phone using the Android™ operating system, an iPad™ or other touchpad or tablet computer, or any other personal media device.

In one embodiment, the alert message 314 is generated by an application or control program program, executed by the personal media device, and includes a push-type message sent for presentation on the display 300, optionally including a source indicator 314a and an alert text 314b. For example, as shown in the figure, the alert message 314 can present a message from an application (in this case, as particularly shown by the source indicator 314a) indicating a desire for user action (in this case, as particularly shown by the alert text 314b).

While, in this example, the alert message 314 generally includes a message deemed by the application or control program to be emergent or otherwise indicating a desire for user action, in the context of the invention, there is no particular requirement for any such limitation. For example, the alert message 314 can include a reminder set by the user for themselves, such as expiry of a timer, or a note set for display, or otherwise. There is no particular requirement that the alert message 314 would actually be considered an “alert” by the user.

Moreover, while, in this example, the alert message 314 generally follows a known format, such as for example including a source indicator 314a and an alert text 314b, in the context of the invention, there is no particular requirement for any such limitation. For example, whether the alert message 314 has any particular structure is optional.

Application Control

In one embodiment, the charging element's display can be controlled by a control program executing on the charging element. The charging element's display can also be controlled by an application executing on the personal media device, or by some combination or conjunction thereof. For example, the application or the control program can alter the brightness of the display element on the charging device, alter one or more display settings for the display element on the charging device, turn an alarm on or off, or alter a volume for an alarm, for the charging device, or otherwise customize display settings (or other settings) for the charging device. More generally, an application program executing on the personal media device can operate in conjunction with, or operate as a substitute for, a control program executing on the charging element, with respect to any operation of the charging element described herein.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. It should be understood that the exemplary procedures described herein can be stored on any computer accessible medium, including a hard drive, RAM, ROM, removable disks, CD-ROM, memory sticks, etc., and executed by a processing arrangement and/or computing arrangement which can be and/or include a hardware processors, microprocessor, mini, macro, mainframe, etc., including a plurality and/or combination thereof. In addition, certain terms used in the present disclosure, including the specification, drawings and numbered paragraphs thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1-16. (canceled)

17. An apparatus, comprising a charging element coupleable to a personal media device, wherein when said personal media device is in a dormant mode, said charging element is responsive to a condition in response to which a user desires an alert, and presents information in response thereto.

18. An apparatus as in claim 17, wherein said charging element is concurrently coupleable to a second personal media device;
wherein when said second personal media device is in a dormant mode, said charging element is responsive to a second condition in response to which a user desires an alert, and presents second information in response thereto; and
wherein said information and said second information differ.

19. An apparatus as in claim 17, comprising a software element executable on said personal media device, wherein said software element includes instructions interpretable by a processor to control one or more display features of said charging element.

20. An apparatus as in claim 17, wherein said display features include one or more of a brightness, a volume, and whether an alarm is on or off.

21. An apparatus as in claim 17, wherein at least one of said condition and said information is responsive to one or more of a change in status of said personal media device.

22. An apparatus as in claim 17, wherein at least one of said condition and said information is responsive to one or more of a new message, a new email message, a new text message, and a new voicemail message.

23. An apparatus as in claim 17, comprising a software element on said personal media device, wherein said software element includes instructions interpretable by a processor to operate in conjunction with said charging element to present information to said user.

24. An apparatus as in claim 17, wherein said charging operation status is responsive to one or more of a battery amount charged, a battery amount left to charge, and a battery charge completion.

25. An apparatus as in claim 17, wherein said condition or said information is responsive to a status of said personal media device.

26. An apparatus as in claim 17, wherein said dormant mode is responsive to one or more of a battery charging operation and a battery conservation operation.

27. An apparatus as in claim 17, wherein said charging element is coupled to a media library, said media library being one or more of local to said charging element, local to said personal media device, remotely accessible to said charging element, and remotely accessible to said personal media device.

28. A non-transitory medium comprising instructions interpretable by a computing device, said instructions directing said computing device to operate a charging element with respect to a personal media device when said personal media device is in a dormant mode to detect a condition in response to which a user desires an alert, and, in response to said condition, to present information for the user.

29. A medium as in claim 28, comprising instructions to detect a second condition in response to which said user desires an alert; and in response to said second condition, to present second information, wherein said information and said second information differ.

30. A medium as in claim 28, comprising instructions:
to operate said charging element with respect to a second personal media device;
when said second personal media device is in a second dormant mode, to detect a second condition in response to which a user desires an alert; and
in response to said condition or said second condition, to present information for the user.

31. A medium as in claim 28, comprising instructions:
to operate said charging element with respect to a second personal media device;
when said second personal media device is in a second dormant mode, to detect a second condition in response to which a user desires an alert; and
in response to said condition or said second condition, to present an indicator of whether said condition or said second condition has occurred.

32. A medium as in claim 28, comprising instructions to monitor a charging operation status of said personal media device, wherein said charging operation status is responsive to one or more of an amount charged and an amount of time left to charge.

33. A medium as in claim 28, wherein at least one of said condition and said information is responsive to a status of said personal media device.

34. A medium as in claim 28, wherein at least one of said condition and said information is responsive to one or more of a battery amount charged, a battery amount left to charge, and a battery charge completion.

35. A medium as in claim 28, wherein at least one of said condition and said information is responsive to a change in status of said personal media device.

36. A medium as in claim 28, wherein at least one of said condition and said information is responsive to one or more of a new message, a new email message, a new text message, and a new voicemail message.

37. A medium as in claim 28, wherein said dormant mode is responsive to one or more of a battery charging operation and a battery conservation operation.

38. A medium as in claim 28, wherein said information is responsive to a media library,
said media library being one or more of local to said charging element, local to said personal media device, remotely accessible to said charging element, and remotely accessible to said personal media device.

39. A medium as in claim 28, wherein said steps of presenting information include presenting one or more of a graphic, a sound, a symbol, a still photo, and a video.
